(19) United States
(12) Patent Application Publication
(10) Pub. No.: US 2013/0080787 A1
(43) Pub. Date: Mar. 28, 2013

(54) MEMORY STORAGE APPARATUS, MEMORY CONTROLLER AND PASSWORD VERIFICATION METHOD

(71) Applicants: Chien-Fu Lee, Yunlin County (TW); Shu-Hua Wang, Nantou County (TW)

(72) Inventors: Chien-Fu Lee, Yunlin County (TW); Shu-Hua Wang, Nantou County (TW)

(73) Assignee: PHISON ELECTRONICS CORP., Miaoli (TW)

(21) Appl. No.: 13/330,607

(22) Filed: Dec. 19, 2011

(30) Foreign Application Priority Data
Sep. 26, 2011 (TW) 100134595

(51) Int. Cl. H04L 9/32; G06F 12/14

(52) U.S. Cl. 713/183; 726/16; 713/189

(57) ABSTRACT

A memory storage apparatus including a connector, a rewritable non-volatile memory module and a memory controller is provided. The memory controller receives a password to be verified, transforms the password into a data stream by using a first unit, generates a cipher text to be verified according to a predetermined data stream and the transformed data stream by using a second unit, and determines whether the cipher text to be verified is the same to a predetermined cipher text stored in the rewritable non-volatile memory module. When the cipher text to be verified is the same to the predetermined cipher text, the memory controller identifies that the password to be verified is validated. Accordingly, the memory storage apparatus can effectively verify a password input by a user, thereby protecting data stored in the rewritable non-volatile memory module.

### CROSS-REFERENCE TO RELATED APPLICATION

This application claims the priority benefit of Taiwan application serial no. 100134595, filed on Sep. 26, 2011. The entirety of the above-mentioned patent application is hereby incorporated by reference herein and made a part of this specification.

### BACKGROUND

1. Technology Field

The present invention relates to a memory storage apparatus. Particularly, the present invention relates to a memory storage apparatus having a password verification function, a memory controller and a password verification method.

2. Description of Related Art

Digital cameras, cell phones, and MP3 players have undergone rapid growth in recent years, so that consumer demands for storage media have also rapidly increased. A rewritable non-volatile memory is one of the most adaptable memories for electronic products due to its characteristics such as data non-volatility, low power consumption, small volume, non-mechanical structure, and high read-and-write speed. A flash drive is a storage apparatus which uses a flash memory as its storage medium. Thus, in recent years, the flash memory industry has become a major part of the electronic industry.

Since a memory storage apparatus has a small size and a large capacity and is easy to carry around, it is widely applied for storing personal data. However, when the memory storage device is accidentally lost, data stored therein are probably stolen. Therefore, it becomes an important issue to be developed to verify the identity of the user that uses the memory storage apparatus.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the present invention is directed to a memory storage apparatus, which is capable of effectively verifying a password input by a user to protect stored data.

The present invention is directed to a memory controller, which is capable of effectively verifying a password input by a user to protect data stored in a rewritable non-volatile memory module.

The present invention is directed to a password verification method, by which a password input by a user is effectively verified to protect data stored in a rewritable non-volatile memory module.

An exemplary embodiment of the present invention provides a memory storage apparatus including a connector, a rewritable non-volatile memory module and a memory controller. The connector is coupled to a host system. The memory controller is coupled to the connector and the rewritable non-volatile memory module. The memory controller receives a user password from the host system, uses a first unit to transform the user password into a first data stream, uses a second unit to generate a predetermined cipher text according to a predetermined data stream and the first data stream, and stores the predetermined cipher text to the rewritable non-volatile memory module. Moreover, the memory controller receives a password to be verified from the host system, uses the first unit to transform the password to be verified into a second data stream, and uses the second unit to generate a cipher text to be verified according to the predetermined data stream and the second data stream. Moreover, the memory controller reads the predetermined cipher text from the rewritable non-volatile memory module and determines whether the cipher text to be verified is the same to the predetermined cipher text. When the cipher text to be verified is the same to the predetermined cipher text, the memory controller identifies that the password to be verified is validated.

An embodiment of the present invention provides a memory storage apparatus including a connector, a rewritable non-volatile memory module and a memory controller. The connector is coupled to a host system. The memory controller is coupled to the connector and the rewritable non-volatile memory module. The memory controller receives a user password having a plurality of bytes from the host system, sums the bytes of the user password to obtain a first sum, and calculates a checksum corresponding to the first sum, wherein the first sum plus the checksum is equal to a predetermined sum. Moreover, the memory controller stores the checksum to the rewritable non-volatile memory module. The memory controller receives a password to be verified and having a plurality of bytes from the host system, sums the bytes of the password to be verified to obtain a second sum, reads the checksum from the rewritable non-volatile memory module, and determines whether a sum of the second sum and the checksum is equal to the predetermined sum. When the sum of the second sum and the checksum is equal to the predetermined sum, the memory controller identifies that the password to be verified is validated.

An embodiment of the present invention provides a memory controller including a host interface, a memory interface and a memory management circuit. The host interface is coupled to a host system, the memory interface is coupled to a rewritable non-volatile memory module, and the memory management circuit is coupled to a connector and the rewritable non-volatile memory module. The memory management circuit receives a user password from the host system, uses a first unit to transform the user password into a first data stream, uses a second unit to generate a predetermined cipher text according to a predetermined data stream and the first data stream, and stores the predetermined cipher text to the rewritable non-volatile memory module. Moreover, the memory management circuit receives a password to be verified from the host system, uses the first unit to transform the password to be verified into a second data stream, and uses the second unit to generate a cipher text to be verified according to the predetermined data stream and the second data stream. Moreover, the memory management circuit reads the predetermined cipher text from the rewritable non-volatile memory module and determines whether the cipher text to be verified is the same to the predetermined cipher text. When the cipher text to be verified is the same to the predetermined cipher text, the memory management circuit identifies that the password to be verified is validated.

An embodiment of the present invention provides a memory controller including a host interface, a memory interface and a memory management circuit. The host interface is coupled to a host system, the memory interface is coupled to a rewritable non-volatile memory module, and the memory management circuit is coupled to a connector and the rewritable non-volatile memory module. The memory management circuit receives a user password having a plurality of bytes from the host system, sums the bytes of the user password to obtain a first sum, and calculates a checksum corresponding to the first sum, wherein the first sum plus the checksum is equal to a predetermined sum. Moreover, the memory management circuit stores the checksum to the rewritable non-volatile memory module. The memory management circuit receives a password to be verified and having a plurality of bytes from the host system, sums the bytes of the password to be verified to obtain a second sum, reads the checksum from the rewritable non-volatile memory module, and determines whether a sum of the second sum and the checksum is equal to the predetermined sum. When the sum of the second sum and the checksum is equal to the predetermined sum, the memory management circuit identifies that the password to be verified is validated.

An embodiment of the present invention provides a password verification method for a memory storage apparatus, where the memory storage apparatus has a rewritable non-volatile memory module. The password verification method includes receiving a user password; using a first unit to transform the user password into a first data stream; inputting a predetermined data stream and the first data stream to a second unit to generate a predetermined cipher text; and storing the predetermined cipher text to the rewritable non-volatile memory module. Additionally, the password verification method still includes receiving a password to be verified; using the first unit to transform the password to be verified into a second data stream; and inputting the predetermined data stream and the second data stream to the second unit to generate a cipher text to be verified. The password verification method further includes reading the predetermined cipher text from the rewritable non-volatile memory module and determining whether the cipher text to be verified is the same to the predetermined cipher text; and if the cipher text to be verified is the same to the predetermined cipher text, identifying that the password to be verified is validated.

An embodiment of the present invention provides a password verification method for a memory storage apparatus, where the memory storage apparatus has a rewritable non-volatile memory module. The password verification method includes receiving a user password having a plurality of bytes; summing the bytes of the user password to obtain a first sum; and calculating a checksum corresponding to the first sum is calculated, wherein the first sum plus the checksum is equal to a predetermined sum. Additionally, the password verification method still includes storing the checksum to the rewritable non-volatile memory module. The password verification method further includes receiving a password to be verified and having a plurality of bytes; summing the bytes of the password to be verified to obtain a second sum; reading the checksum from the rewritable non-volatile memory module; determining whether a sum of the second sum and the checksum is equal to the predetermined sum; and if the sum of the second sum and the checksum is equal to the predetermined sum, identifying that the password to be verified is validated.

An embodiment of the present invention provides a password verification method, which is adapted to a memory storage apparatus, where the memory storage apparatus has a rewritable non-volatile memory module. The password verification method includes receiving a user password; using a first unit to transform the user password into a first data stream; using a second unit to transform the first data stream into authentication data different to the first data stream; and storing the authentication data to the rewritable non-volatile memory module. The password verification method further includes receiving a password to be verified; using the first unit to transform the password to be verified into a second data stream; generating data to be verified through the second unit; reading the authentication data from the rewritable non-volatile memory module; determining whether the data to be verified and the authentication data are complied with a predetermined rule; and if the data to be verified and the authentication data are complied with the predetermined rule, identifying that the password to be verified is validated.

According to the above descriptions, the memory storage apparatus, the memory controller and the password verification method of the present invention can effectively protect the stored data to avoid unauthorized access.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic flowchart illustrating a method of setting a user password according to an embodiment of the present invention.

FIG. 1B is a schematic flowchart illustrating a method of verifying a user identity according to an embodiment of the present invention.

FIG. 2A is a schematic diagram of a host system and a memory storage apparatus according to a first exemplary embodiment of the present invention.

FIG. 2B is a schematic diagram illustrating a computer, input/output devices and memory storage apparatus according to the first exemplary embodiment of the present invention.

FIG. 2C is a schematic diagram illustrating a host system and a memory storage apparatus according to another exemplary embodiments of the present invention.

FIG. 3A is a schematic block diagram of a memory storage apparatus of FIG. 2A.

FIG. 3B is a schematic block diagram of a memory controller according to the first exemplary embodiment of the present invention.

FIG. 4A and FIG. 4B are schematic diagrams illustrating examples of managing physical blocks a rewritable non-volatile memory module according to an exemplary embodiment of the present invention.

FIG. 5 is a schematic diagram illustrating an example of managing logical blocks according to the first exemplary embodiment of the present invention.

FIG. 6 is a schematic diagram of setting a user password according to the first exemplary embodiment of the present invention.

FIG. 7 is a flowchart illustrating a method of setting a user password according to the first exemplary embodiment of the present invention.

FIG. 8 is a schematic diagram of verifying a user ID according to the first exemplary embodiment of the present invention.

FIG. 9 is a flowchart illustrating a method of verifying a user ID according to the first exemplary embodiment of the present invention.

FIG. 10 is a schematic diagram of setting a user password according to a second exemplary embodiment of the present invention.

FIG. 11 is a flowchart illustrating a method of setting a user password according to the second exemplary embodiment of the present invention.

FIG. 12 is a schematic diagram of verifying a user ID according to the second exemplary embodiment of the present invention.

FIG. 13 is a flowchart illustrating a method of verifying a user ID according to the second exemplary embodiment of the present invention.

FIG. 14 is a schematic diagram of setting a user password according to a third exemplary embodiment of the present invention.

FIG. 15 is a flowchart illustrating a method of setting a user password according to the third exemplary embodiment of the present invention.

FIG. 16 is a schematic diagram of verifying a user ID according to the third exemplary embodiment of the present invention.

FIG. 17 is a flowchart illustrating a method of verifying a user ID according to the third exemplary embodiment of the present invention.

FIG. 18 is a schematic diagram of setting a user password according to a fourth exemplary embodiment of the present invention.

FIG. 19 is a flowchart illustrating a method of setting a user password according to the fourth exemplary embodiment of the present invention.

FIG. 20 is a schematic diagram of verifying a user ID according to the fourth exemplary embodiment of the present invention.

FIG. 21 is a flowchart illustrating a method of verifying a user ID according to the fourth exemplary embodiment of the present invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

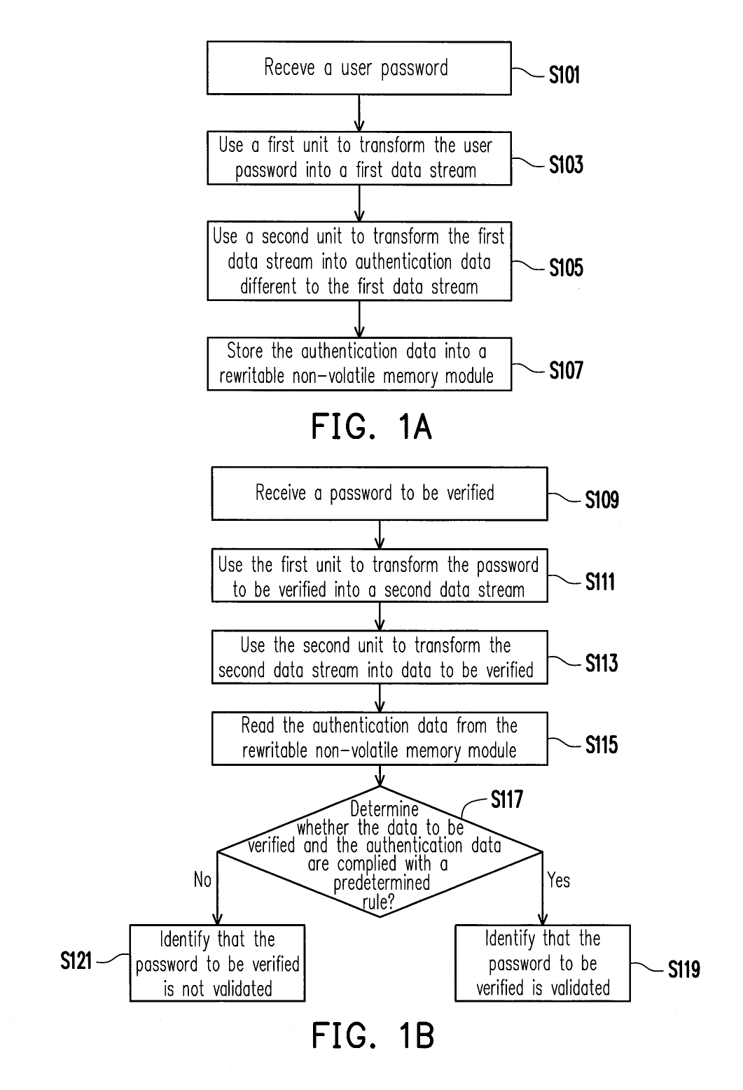

In order to protect stored data to avoid unauthorized access, the present invention provides a password verification method. In the method, a password setting process is as that shown in FIG. 1A, by which a user password is received (S101), a first unit is used to transform the user password into a first data stream (S103), a second unit is used to transform the first data stream into authentication data different to the first data stream (S105), and the authentication data is stored to a rewritable non-volatile memory module (step S107). Then, an identification (ID) verification procedure is as that shown in FIG. 1B, by which a password to be verified is received (S109), the first unit is used to transform the password to be verified into a second data stream (S111), and the second unit is used to transform the second data stream into data to be verified (S113). The authentication data is read from the rewritable non-volatile memory module (S115), and it is determined whether the data to be verified and the authentication data are complied with a predetermined rule (S117), where when the data to be verified and the authentication data are complied with the predetermined rule, the password to be verified is identified to be validated (S119), and conversely, the password to be verified is identified to be not validated (S121). In this way, the method of the invention can effectively verify the ID of the user. In order to fully convey the spirit of the invention to those skilled in the art, exemplary embodiments are provided below for detail descriptions

### First Exemplary Embodiment

Generally, the memory storage apparatus (which is also referred to as a memory storage system) includes a rewritable non-volatile memory module and a controller (which is also referred to as a control circuit). The memory storage apparatus is generally used together with a host system, and the host system can write data into the memory storage apparatus or read data from the memory storage apparatus.

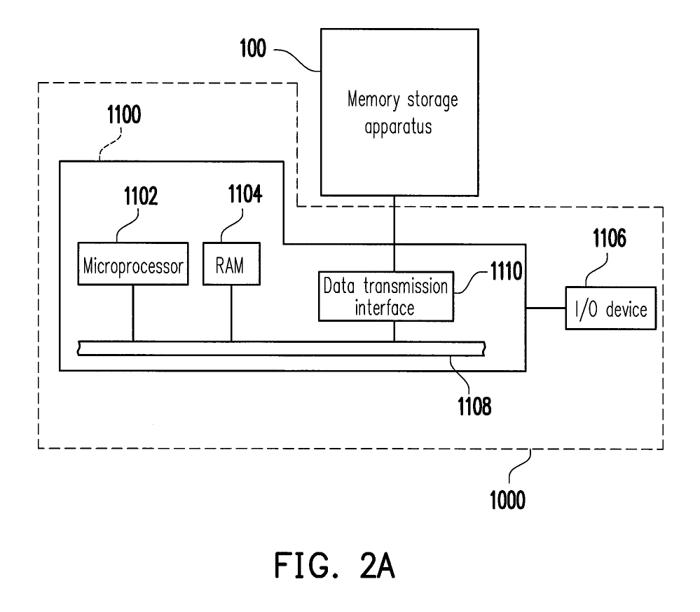

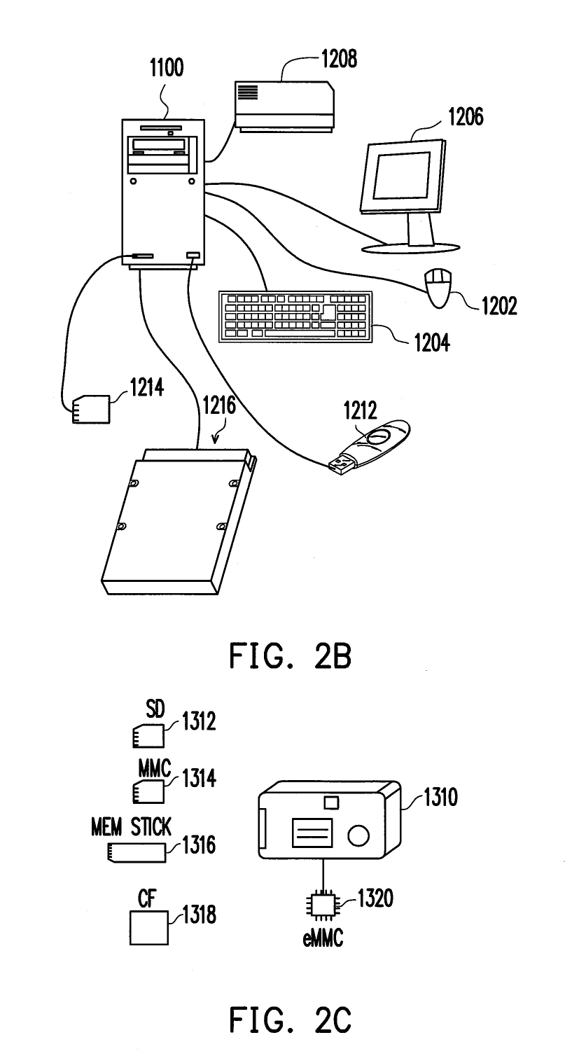

FIG. 2A is a schematic diagram of a host system and a memory storage apparatus according to a first exemplary embodiment of the present invention.

Referring to FIG. 2A, the host system 1000 generally includes a computer 1100 and an input/output (I/O) device 1106. The computer 1100 includes a microprocessor 1102, a random access memory (RAM) 1104, a system bus 1108 and a data transmission interface 1110. The I/O device 1106 includes a mouse 1202, a keyboard 1204, a display 1206 and a printer 1208 as that shown in FIG. 2B. It should be noticed that the devices shown in FIG. 2B are not used to limit the I/O device 1106, and the I/O device 1106 can also include other devices.

In the present embodiment, the memory storage apparatus 100 is coupled to other devices of the host system 1000 through the data transmission interface 1110. Based on operations of the microprocessor 1102, the RAM 1104, and the I/O device 1106, data can be written into the memory storage apparatus 100 or read from the memory storage apparatus 100. For example, the memory storage apparatus 100 can be a rewritable non-volatile memory storage device such as a flash drive 1212, a memory card 1214 or a solid state drive (SSD) 1216 shown in FIG. 2B.

Generally, the host system 1000 can be any system substantially used together with the memory storage apparatus 100 for storing data. In the present exemplary embodiment, although the host system 1000 implemented by a computer system is taken as an example, in another exemplary embodiment of the present invention, the host system 1000 can also be a digital camera, a video camera, a communication device, an audio player or a video player, etc. For example, when the host system is a digital camera (video camera) 1310, the rewritable non-volatile memory storage apparatus is a secure digital (SD) card 1312, a multimedia card (MMC) card 1314, a memory stick (MS) 1316, a compact flash (CF) card 1318 or an embedded storage device 1320 (shown in FIG. 2C). The embedded storage device 1320 includes an embedded MMC (eMMC). It should be noticed that the eMMC is directly coupled to a substrate of the host system.

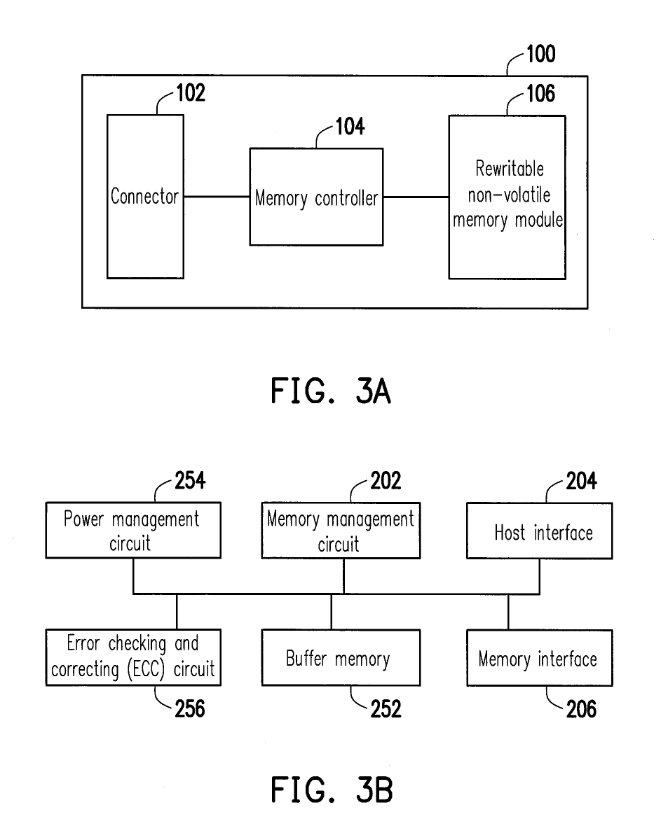

FIG. 3A is a schematic block diagram of a memory storage apparatus according to the first exemplary embodiment of the present invention.

Referring to FIG. 3A, the memory storage apparatus 100 includes a connector 102, a memory controller 104 and a rewritable non-volatile memory module 106.

In the present exemplary embodiment, the connector 102 complies with a universal serial bus (USB) standard. However, it should be noticed that the present invention is not limited thereto, and the connector 102 may also comply with an institute of electrical and electronic engineers (IEEE) 1394 standard, a peripheral component interconnect express (PCI express) standard, a parallel advanced technology attachment (PATA) standard, a serial advanced technology attachment (SATA) standard, a secure digital (SD) interface standard, a memory stick (MS) interface standard, a multi media card (MMC) interface standard, a compact flash (CF) interface standard, an integrated drive electronics (IDE) interface standard or other suitable standards.

The memory controller 104 may execute a plurality of logic gates or control instructions implemented by a hardware form or a firmware form, and may perform a program (i.e., write) operation, a read operation or an erase operation on the rewritable non-volatile memory module 106 according to operation commands of the host system 1000.

The rewritable non-volatile memory module 106 is coupled to the memory controller 104 and has a plurality of physical blocks for storing data written by the host system 1000. In the present exemplary embodiment, each physical block has a plurality of physical pages, wherein the physical pages belonging to the same physical block are independently written and are simultaneously erased. For example, each physical block is composed of 128 physical pages, and each physical page has a capacity of 4 kilobyte (KB). However, it should be noticed that the present invention is not limited thereto, and each physical block can be composed of 64 physical pages, 256 physical pages or any other number of the physical pages.

To be specific, physical block is the smallest unit for erasing data. Namely, each physical block contains the least number of memory cells that are erased all together. Physical page is the smallest unit for programming data. Namely, physical page is the smallest unit for writing data. However, in another exemplary embodiment of the present invention, the smallest unit for writing data may also be sector or any other unit. Each physical page usually includes a data bit area and a redundant bit area. The data bit area is used for storing user data, and the redundant bit area is used for storing system data (for example, error checking and correcting (ECC) codes).

In the present exemplary embodiment, the rewritable non-volatile memory module 106 is a multi level cell (MLC) NAND flash memory module. However, the present invention is not limited thereto, and the rewritable non-volatile memory module 106 may also be a single level cell (SLC) NAND flash memory module, other flash memory modules or other memory modules having the same characteristic.

FIG. 3B is a schematic block diagram of a memory controller according to the first exemplary embodiment of the present invention.

Referring to FIG. 3B, the memory controller 104 includes a memory management circuit 202, a host interface 204 and a memory interface 206.

The memory management circuit 202 is configured for controlling a whole operation of the memory controller 104. In detail, the memory management circuit 202 has a plurality of control instructions, and when the memory storage apparatus 100 is in operation, these control instructions are executed to perform various operations, such as data write, read and erase operations in the rewritable non-volatile memory module 106.

In the present exemplary embodiment, the control instructions of the memory management circuit 202 are implemented by a firmware form. For example, the memory management circuit 202 has a micro processing unit (not shown) and a read-only memory (not shown), and these control instructions are burned into the read-only memory. When the memory storage apparatus 100 is in operation, these control instructions are executed by the micro processing unit to carry out various data operations such as data write, read and erase operations.

In another exemplary embodiment, the control instructions of the memory management circuit 202 may also be stored in a specific area (for example, a system area used for storing system data in the memory module) of the rewritable non-volatile memory module 106 as program codes. Moreover, the memory management circuit 202 has a micro processing unit (not shown), a read-only memory (not shown) and a random access memory (RAM) (not shown). Particularly, the read-only memory has a boot code, and when the memory controller 104 is enabled, the micro processing unit first executes the boot code to load the control instructions stored in the rewritable non-volatile memory module 106 to the RAM of the memory management circuit 202. Then, the micro processing unit executes these control instructions to perform various data operations such as data write, read and erase operations.

Moreover, in another exemplary embodiment of the present invention, the control instructions of the memory management circuit 202 may also be implemented in a hardware form. For example, the memory management circuit 202 includes a data writing circuit, a data reading circuit and a data erasing circuit, etc.

The host interface 204 is coupled to the memory management circuit 202, and is configured for receiving and recognizing commands and data transmitted by the host system 1000. Namely, the commands and data transmitted by the host system 1000 are transmitted to the memory management circuit 202 through the host interface 204. In the present exemplary embodiment, the host interface 204 complies with the SATA standard. However, the present invention is not limited thereto, and the host interface 204 may also comply with the PATA standard, the IEEE 1394 standard, the PCI express standard, the USB standard, the SD standard, the MS standard, the MMC standard, the CF standard, the IDE standard or other suitable data transmission standards.

The memory interface 206 is coupled to the memory management circuit 202 and is configured to access the rewritable non-volatile memory module 106. Namely, data to be written into the rewritable non-volatile memory module 106 is converted into a format that can be accepted by the rewritable non-volatile memory module 106 through the memory interface 206.

In an exemplary embodiment of the invention, the memory controller 104 further includes a buffer memory 252, a power management circuit 254 and an error checking and correcting (ECC) circuit 256.

The buffer memory 252 is coupled to the memory management circuit 202 and is configured for temporarily storing data and commands from the host system 1000 or data from the rewritable non-volatile memory module 106.

The power management circuit 254 is coupled to the memory management circuit 202 and is configured for controlling the power of the memory storage apparatus 100.

The ECC circuit 256 is coupled to the memory management circuit 202 and is configured to execute an error checking and correcting procedure to ensure correctness of data. In detail, when the memory management circuit 202 receives a write command from the host system 1000, the ECC circuit 256 generates a corresponding error checking and correcting code (ECC code) for data corresponding to the write command, and the memory management circuit 202 writes the data corresponding to the write command and the corresponding ECC code together to the rewritable non-volatile memory module 106. Then, when the memory management circuit 202 reads data from the rewritable non-volatile memory module 106, it simultaneously reads the ECC code corresponding to the data, and the ECC circuit 256 executes the error checking and correcting procedure on the read data according to the ECC code.

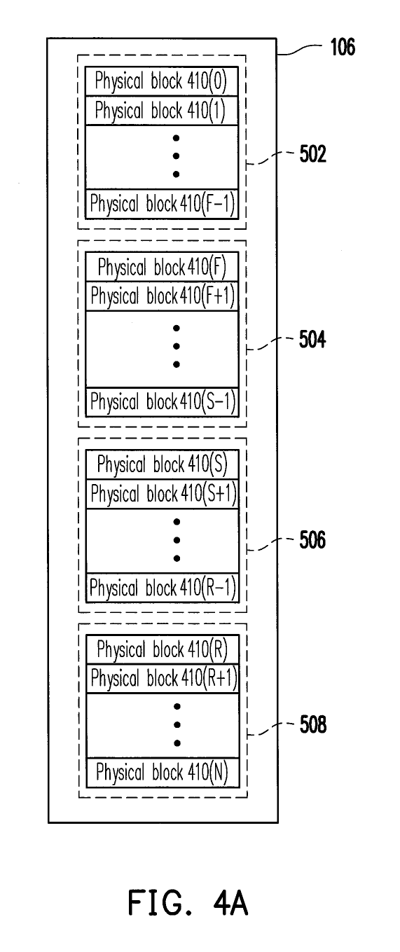

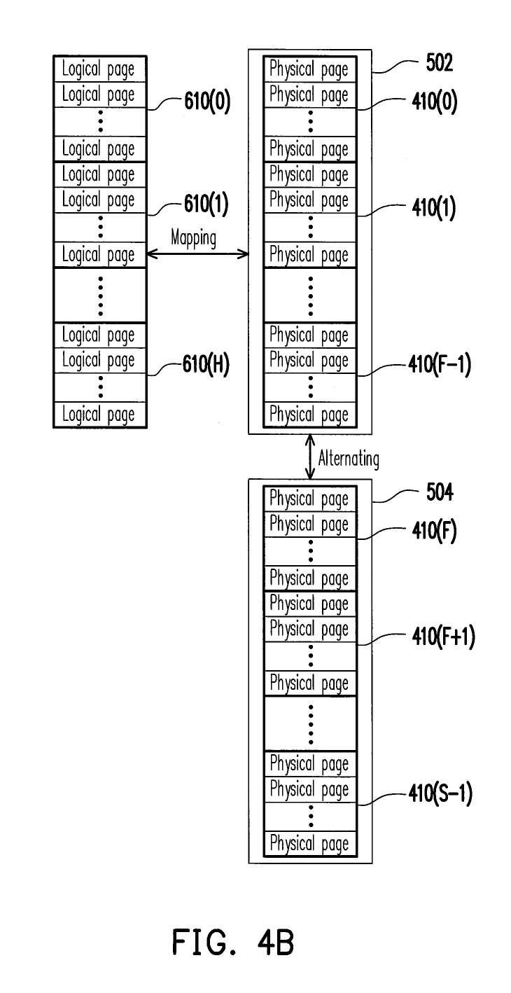

FIG. 4A and FIG. 4B are schematic diagrams illustrating examples of managing physical blocks the rewritable non-volatile memory module according to the first exemplary embodiment of the present invention.

Referring to FIG. 4A, the rewritable non-volatile memory module 106 has physical blocks 410(0)-410(N), and the memory management circuit 202 of the memory controller 104 logically groups the physical blocks 410(0)-410(N) into a data area 502, a spare area 504, a system area 506 and a replacement area 508.

The physical blocks logically belonged to the data area 502 and the spare area 504 are used to store data from the host system 1000. In detail, the physical blocks of the data area 502 (which are also referred to as data physical blocks) are regarded as physical blocks already stored with data, and the physical blocks of the spare area 504 (which are also referred to as spare physical blocks) are used to for writing new data. For example, when the host system 1000 receives a write command and data to be written, the memory management circuit 202 selects a physical block from the spare area 504 to serve as a log physical block, and write the data into the log physical block. For another example, when a data merging operation is performed to a certain logical block, the memory management circuit 202 selects a physical block from the spare area 504 to serve as a new data physical block corresponding to the logical block for writing data, and substitute the data physical block originally mapped to the logical block. Particularly, after the data merging operation is completed, the data physical block or the log physical block storing invalid data is re-associated (or retrieved) with the spare area 504 for utilization of a next time.

The physical blocks logically belonged to the system area 506 are used for storing system data. For example, the system data includes manufacturer and a model number of the rewritable non-volatile memory module, the number of the physical blocks of the rewritable non-volatile memory module, and the number of physical pages in each physical block, etc.

The physical blocks logically belonged to the replacement area 508 are used to a bad physical block replacing procedure for replacing bad physical blocks. In detail, when the replacement area 508 still has normal physical blocks and some physical blocks in the data area 502 are damaged, the memory management circuit 202 gets the normal physical blocks from the replacement area 508 to replace the bad physical blocks.

According to the above descriptions, when the memory storage apparatus 100 is in operation, the physical blocks of the data area 502, the spare area 504, the system area 506 and the replacement area 508 are dynamically changed. For example, the physical blocks used for storing data in alternation are variably belonged to the data area 502 or the spare area 504.

It should be noticed that in the present exemplary embodiment, the memory management circuit 202 performs the management in a unit of physical block. However, the present invention is not limited thereto, and in another exemplary embodiment, the memory management circuit 202 may also group the physical blocks into a plurality of physical units, and performs the management in units of each physical unit. For example, each physical unit is composed of at least one physical block of the same memory sub module or different memory sub modules.

Referring to FIG. 4B, the memory management circuit 202 configures logical blocks 610(0)-610(H) for mapping to the physical blocks of the data area 502, where each logical block has a plurality of logical pages, and the logical pages are sequentially mapped to the physical pages of the corresponding data physical block. For example, when the memory storage apparatus 100 is initialised, the logical blocks 610(0)-610(H) are initially mapped to the physical blocks 410(0)-410(F−1) of the data area 502.

In the present exemplary embodiment, the memory management circuit 202 maintains a logical block-physical block mapping table to record a mapping relationship between the logical blocks 610(0)-610(H) and the physical blocks of the data area 502. For example, when the host system 1000 is about to access a certain logical access address, the memory management circuit 202 converts the logical access address accessed by the host system 1000 into a multidimensional address composed of a corresponding logical block and a corresponding logical page, and accesses data at the mapped physical page according to the logical block-physical block mapping table.

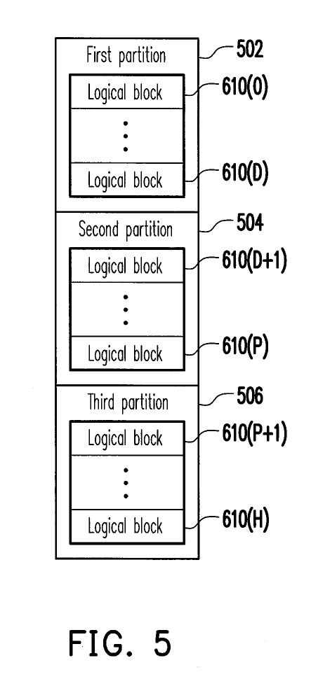

FIG. 5 is a schematic diagram illustrating an example of managing logical blocks according to the first exemplary embodiment of the present invention.

Referring to FIG. 5, the memory management circuit 202 divides the logical blocks 610(0)-610(H) into a first partition 502, a second partition 504 and a third partition 506. For example, the logical blocks 610(0)-610(D) are belonged to the first partition 502, the logical blocks 610(D+1)-610(P) are belonged to the second partition 504, and the logical blocks 610(P+1)-610(H) are belonged to the third partition 506.

The first partition 502 is used for storing application programs developed by a manufacturer of the memory storage apparatus 100, for example, a password verification program. In the present embodiment, each time when the memory storage apparatus 100 is connected to the host system 1000, the password verification program stored in the first partition 502 is executed for the user to input a password for password verification. A detailed password verification mechanism is described below with reference of figures.

The memory management circuit 202 initially sets a storage attribute of the first partition 502 to a read-only state to avoid the user deleting the data or programs stored in the first partition 502 by mistake. However, the present invention is not limited thereto, and the storage attribute of the first partition 502 may also be set to a read-write state.

Moreover, in another exemplary embodiment of the present invention, the memory management circuit 202 may also set the first partition 502 as a multimedia partition. In detail, when the memory storage apparatus 100 is coupled to the host system 1000, the memory management circuit 202 notifies the host system 1000 that the first partition 502 is a partition of an optical storage device (which is also referred to as an optical disc partition). For example, the first partition 502 is simulated as a partition of an optical disc drive, a digital video disc (DVD) drive or a blue-ray disc drive. Particularly, in the present exemplary embodiment, besides the password verification program, the first partition 502 may store an auto executable file. Here, the auto executable file is a script file that can be automatically executed by an operating system of the host system 1000 (for example, a script file with a file name of “Autorun.inf”), and a content of the auto executable file includes a script language of executing the above password verification program. Therefore, when the memory storage apparatus 100 is connected to the host system 1000, the password verification program is automatically executed to request the user to input the password.

The second partition 504 is a storage partition provided to the user for storing data. Particularly, in the present exemplary embodiment, the memory management circuit 202 initially sets the second partition 504 as a hidden partition that cannot be recognized by the host system 1000, and after the ID of the user is verified, the memory management circuit 202 sets the second partition 504 as a storage partition that can be accessed by the host system 1000. In detail, when the memory storage apparatus 100 is connected to the host system 1000, the operating system of the host system 1000 cannot recognize and access the second partition 504 (i.e. the user cannot view the second partition 504 in a file system). Then, if the password input by the user is verified to be validated, the memory management circuit 202 reconfigures the second partition 504, so that the operating system of the host system 1000 can recognize and access the second partition 504.

The third partition 506 is a confidential partition that might only be accessed by the memory management circuit 202. Namely, the operating system of the host system 1000 cannot access data stored in the third partition 506.

It should be noticed that in the present exemplary embodiment, although the memory management circuit 202 divides the logical blocks into three partitions for management, the present invention is not limited thereto. In another exemplary embodiment of the present invention, the memory management circuit 202 may also divides the logical blocks into more partitions.

As described above, the user has to pass through the ID verification in order to access the second partition 504. For example, the memory storage apparatus 100 is initially set with a predetermined password by the manufacturer, and in the ID verification procedure, the user can pass through the ID verification by using the predetermined password, and then resets a user password.

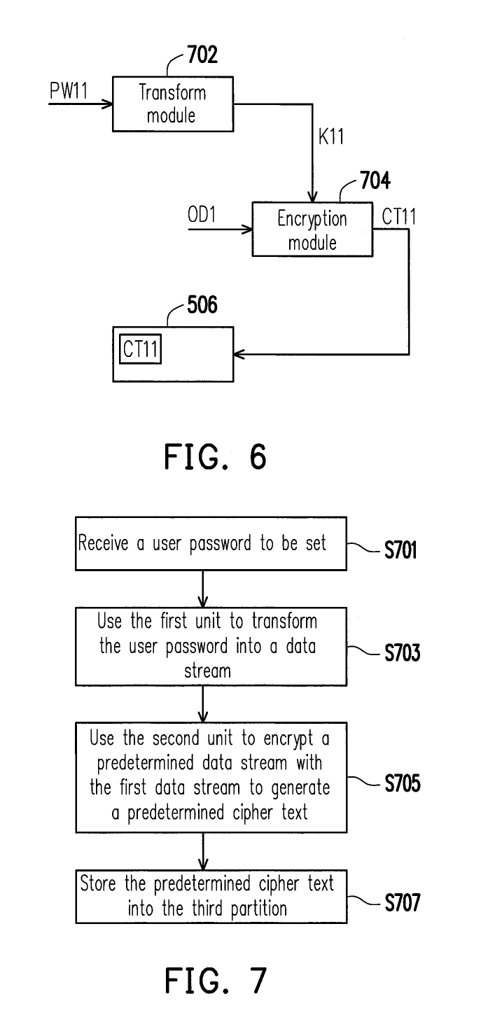

FIG. 6 is a schematic diagram of setting a user password according to the first exemplary embodiment of the present invention.

Referring to FIG. 6, after the user executes the password setting function in the password verification program executed on the host system 1000 to input a new user password PW11, the user password PW11 is transmitted to the memory storage apparatus 100. When the memory controller 104 receives the user password PW11, the memory management circuit 202 converts the user password PW11 into a data stream K11.

In detail, in the first exemplary embodiment, a transform module 702 and an encryption module 704 are disposed in the memory storage apparatus 100 to respectively serve as the aforementioned first unit and second unit. The memory management circuit 202 uses the transform module 702 to transform an input data stream into an output data stream with a fixed length. For example, when a length of the input data stream is smaller than the fixed length, the transform module 702 adds padding bits to the input data stream to produce the output data stream having the fixed length. Alternatively, when the length of the input data stream is greater than the fixed length, the transform module 702 sections the input data stream by the fixed length and executes an XOR operation to produce the output data stream. It should be noticed that in the present exemplary embodiment, although a physical circuit is used to serve as the transform module 702, the invention is not limited thereto. For example, in another exemplary embodiment of the present invention, the transform module 702 may also be implemented by program codes.

Then, the memory management circuit 202 uses the encryption module 704 to encrypt a predetermined data stream OD1 with the data stream K11 to produce a predetermined cipher text CT11. In detail, the encryption module 704 may be an advanced encryption standard (AES) module, and the memory management circuit 202 takes the data stream K11 as a key of the encryption module 704 to encrypt the predetermined data stream OD1 to produce the predetermined cipher text CT11. Here, the predetermined data is pre-stored in the memory management circuit 202, which may be an identifier or a manufacturer name of the rewritable non-volatile memory module 106. It should be notice that the fixed length is determined according to a type of the encryption module 704. For example, when the encryption module 704 is implemented according to an AES 128, the fixed length is set to 16 bits, and when the encryption module 704 is implemented according to an AES 256, the fixed length is set to 32 bits. It should be noticed that in the present exemplary embodiment, although the encryption module 704 is implemented according to the AES, the present invention is not limited thereto. For example, the encryption module 704 may also be implemented according to a data encryption standard (DES). It should be noticed that in the present exemplary embodiment, although the encryption module 704 is implemented by the physical circuit, the invention is not limited thereto. For example, in another exemplary embodiment of the present invention, the encryption module 704 may also be implemented by program codes.

Then, the memory management circuit 202 stores the predetermined cipher text CT11 to the third partition 506 to complete the setting of the new user password. It should be noticed that in the present exemplary embodiment, although the memory management circuit 202 stores the predetermined cipher text CT11 to the third partition 506, the present invention is not limited thereto.

FIG. 7 is a flowchart illustrating a method of setting the user password according to the first exemplary embodiment of the present invention.

Referring to FIG. 7, in step S701, a user password to be set is received. Then, in step 5703, the first unit (for example, the transform module 702) is used to transform the user password into a data stream (which is referred to as a first data stream). In step S705, the second unit (for example, the encryption module 704) is used to encrypt a predetermined data stream with the first data stream to generate a predetermined cipher text. Finally, in step S707, the predetermined cipher text is stored to the third partition 506.

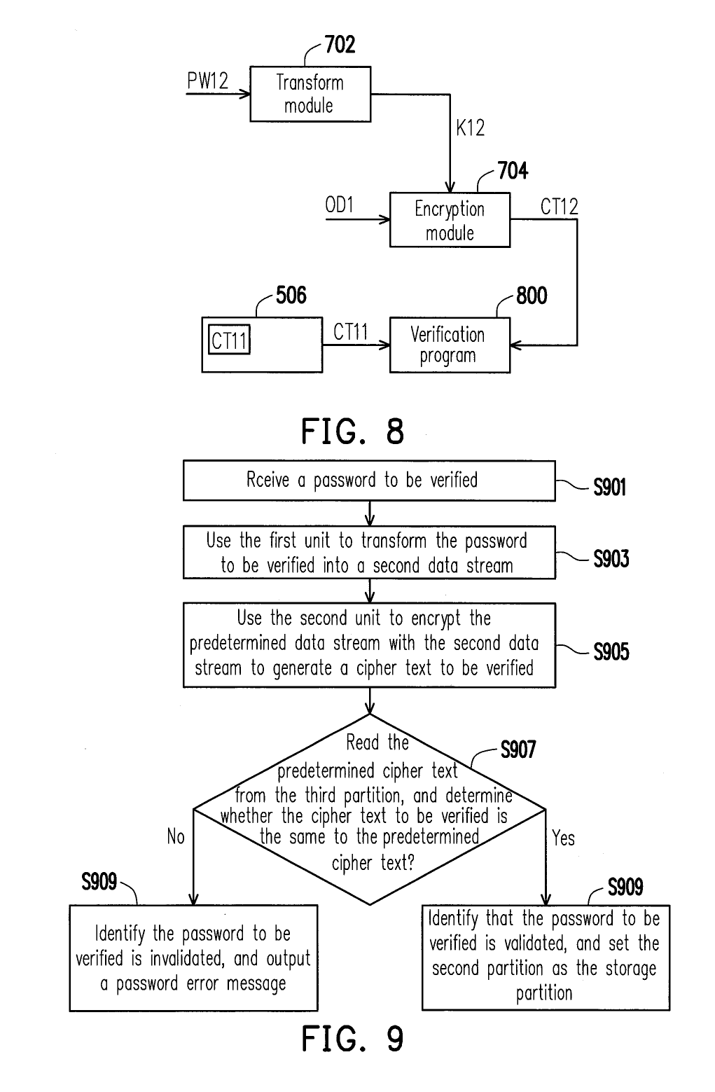

FIG. 8 is a schematic diagram of verifying the user ID according to the first exemplary embodiment of the present invention.

Referring to FIG. 8, when the user inputs a password PW12 (which is referred to as a password to be verified) according to the request of the password verification program, the password to be verified PW12 is transmitted to the memory storage apparatus 100.

When the memory controller 104 receives the password to be verified PW12, the memory management circuit 202 uses the transform module 702 to transform the password to be verified PW12 into a data stream K12.

Then, the memory management circuit 202 uses the encryption module 704 to encrypt the predetermined data stream OD1 by the data stream K12 to generate a cipher text to be verified CT12.

Then, the memory management circuit 202 reads the predetermined cipher text CT11 from the third partition 506 and performs a verification procedure 800 according to the cipher text to be verified CT12 and the predetermined cipher text CT11. In detail, if the password to be verified PW12 is the same to the user password PW11, the cipher text to be verified CT12 should be the same to the predetermined cipher text CT11. Comparatively, if the password to be verified PW12 is different to the user password PW11, the cipher text to be verified CT12 could be different to the predetermined cipher text CT11. Particularly, in case that the password to be verified is identified to be validated, the memory management circuit 202 sets the second partition 504 originally set as the hidden partition to the storage partition that can be accessed by the host system 1000.

FIG. 9 is a flowchart illustrating a method of verifying the user ID according to the first exemplary embodiment of the present invention.

Referring to FIG. 9, in step S901, a password to be verified is received. Then, in step S903, the first unit is used to transform the password to be verified into a data stream (which is referred to as a second data stream), and in step S905, the second unit is used to encrypt the predetermined data stream with the second data stream to generate a cipher text to be verified. Moreover, in step S907, the predetermined cipher text is read from the third partition 506, and it is determined whether the cipher text to be verified is the same to the predetermined cipher text.

When the cipher text to be verified is the same to the predetermined cipher text, in step S909, the password to be verified is identified to be validated, and the second partition 504 is set as the storage partition.

When the cipher text to be verified is different to the predetermined cipher text, in step S911, the password to be verified is identified to be invalidated, and a password error message is output.

It should be noticed that in the present exemplary embodiment, the second partition 504 is initially set as the hidden partition that cannot be recognized by the host system 1000, and after the password to be verified is identified to be validated, the second partition 504 is set as the storage partition that can be accessed by the host system 1000, so as to avoid unauthorized access of the stored data. However, the present invention is not limited thereto.

In another exemplary embodiment of the present invention, the second partition 504 may be initially set as the storage partition that can be recognized and accessed by the host system 1000, and any data stored to the second partition 504 is ciphered by a partition key, so as to protect the stored data. In detail, after the password to be verified is identified to be validated, the memory management circuit 202 uses the partition key used for encrypting the data of the second partition 504 to decrypt the data to be accessed, so as to try to ensure that only an authorized user can correctly access data. For example, the partition key is stored in the third partition 506.

### Second Exemplary Embodiment

The second exemplary embodiment is substantially the same to the first exemplary embodiment, and a difference there between is that the memory management circuit of the second exemplary embodiment uses a different method to perform ID verification. FIGS. 2A, 3A, 3B, 4A, 4B and 5 of the first exemplary embodiment are referenced to describe the difference of the first exemplary embodiment and the second exemplary embodiment.

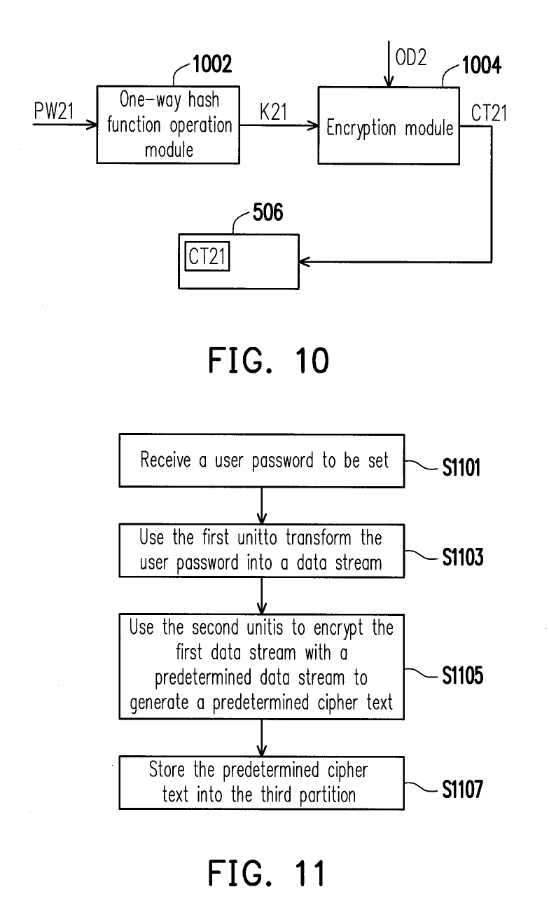

FIG. 10 is a schematic diagram of setting a user password according to the second exemplary embodiment of the invention.

Referring to FIG. 10, after the user executes the password setting function in the password verification program executed on the host system 1000 to input a new user password PW21, the user password PW21 is transmitted to the memory storage apparatus 100. When the memory controller 104 receives the user password PW21, the memory management circuit 202 converts the user password PW21 into a data stream K21.

In detail, in the second exemplary embodiment, a one-way hash function operation module 1002 and an encryption module 1004 are configured in the memory storage apparatus 100 to respectively serve as the aforementioned first unit and second unit. The memory management circuit 202 uses the one-way hash function operation module 1002 to transform the user password PW21 into the data stream K21. It should be noticed that in the present exemplary embodiment, although the one-way hash function operation module 1002 is implemented by a physical circuit, the present invention is not limited thereto. For example, in another embodiment of the present invention, the one-way hash function operation module 1002 may also be implemented by program codes.

Then, the memory management circuit 202 uses the encryption module 1004 to encrypt the data stream K21 with a predetermined data stream OD2 to produce a predetermined cipher text CT21. In detail, the encryption module 1004 may be an advanced encryption standard (AES) function, and the memory management circuit 202 takes the predetermined data stream OD2 as a key of the encryption module 1004 to encrypt the data stream K21 to produce the predetermined cipher text CT21. Here, the predetermined data is pre-stored in the memory management circuit 202 and has a fixed length. For example, the predetermined data may be composed of a word string of an identifier or a manufacturer name of the rewritable non-volatile memory module 106. It should be notice that the fixed length is determined according to a type of the encryption module 1004. For example, when the encryption module 1004 is implemented according to the AES 128, the fixed length is set to 16 bits, and when the encryption module 1004 is implemented according to the AES 256, the fixed length is set to 32 bits. It should be noticed that in the present exemplary embodiment, although the encryption module 1004 is implemented according to the AES, the present invention is not limited thereto. For example, the encryption module 1004 may also be implemented according to a data encryption standard (DES). It should be noticed that in the present exemplary embodiment, although the encryption module 1004 is implemented by the physical circuit, the present invention is not limited thereto. For example, in another exemplary embodiment of the present invention, the encryption module 1004 may also be implemented by program codes.

Then, the memory management circuit 202 stores the predetermined cipher text CT21 to the third partition 506 to complete the setting of the new user password.

FIG. 11 is a flowchart illustrating a method of setting the user password according to the second exemplary embodiment of the present invention.

Referring to FIG. 11, in step S1101, a user password to be set is received. Then, in step S1103, the first unit (for example, the one-way hash function operation module 1002) is used to transform the user password into a data stream (which is referred to as a first data stream). In step S1105, the second unit (for example, the encryption module 1004) is used to encrypt the first data stream with a predetermined data stream to generate a predetermined cipher text. Finally, in step S1107, the predetermined cipher text is stored to the third partition 506.

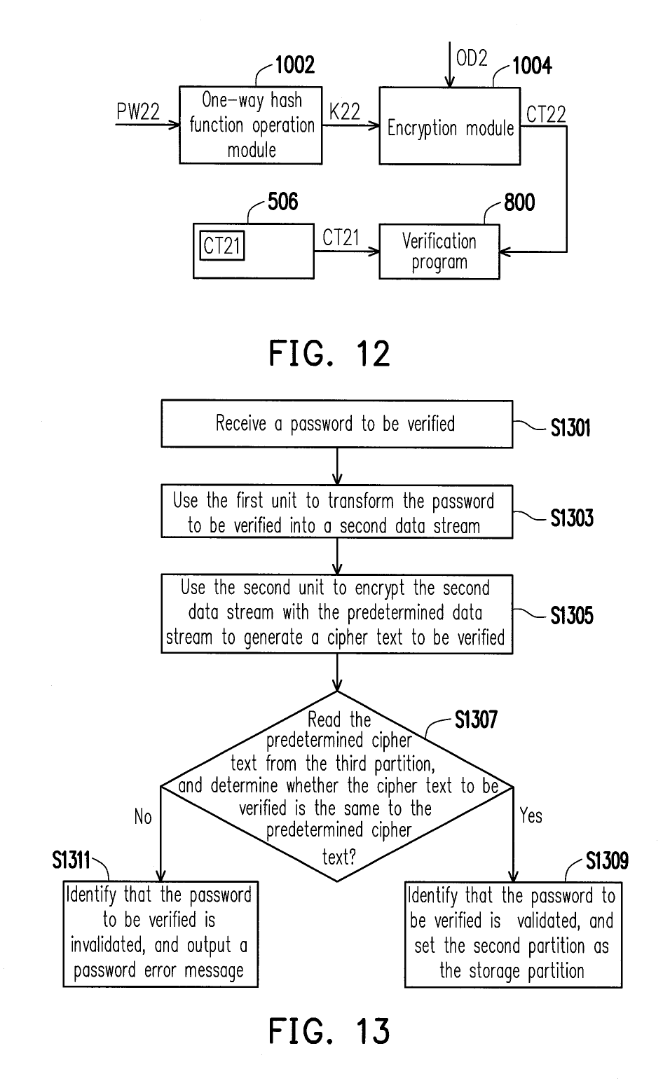

FIG. 12 is a schematic diagram of verifying the user ID according to the second exemplary embodiment of the invention.

Referring to FIG. 12, when the user inputs a password PW22 (which is referred to as a password to be verified) according to the request of the password verification program, the password to be verified PW22 is transmitted to the memory storage apparatus 100.

When the memory controller 104 receives the password to be verified PW22, the memory management circuit 202 uses the one-way hash function operation module 1002 to transform the password to be verified PW22 into a data stream K22.

Then, the memory management circuit 202 uses the encryption module 1004 to encrypt the data stream K22 with the predetermined data stream OD1 to generate a cipher text to be verified CT22.

Then, the memory management circuit 202 reads the predetermined cipher text CT21 from the third partition 506 and performs a verification procedure 800 according to the cipher text to be verified CT22 and the predetermined cipher text CT21. In detail, if the password to be verified PW22 is the same to the user password PW21, the cipher text to be verified CT22 should be the same to the predetermined cipher text CT21. Comparatively, if the password to be verified PW22 is different to the user password PW21, the cipher text to be verified CT22 could be different to the predetermined cipher text CT21. Particularly, in case that the password to be verified is identified to be validated, the memory management circuit 202 sets the second partition 504 originally set as the hidden partition to the storage partition that can be accessed by the host system 1000.

FIG. 13 is a flowchart illustrating a method of verifying the user ID according to the second exemplary embodiment of the present invention.

Referring to FIG. 13, in step S1301, a password to be verified is received. Then, in step S1303, the first unit is used to transform the password to be verified into a data stream (which is referred to as a second data stream), and in step S1305, the second unit is used to encrypt the second data stream with the predetermined data stream to generate a cipher text to be verified. Moreover, in step 51307, the predetermined cipher text is read from the third partition 506, and it is determined whether the cipher text to be verified is the same to the predetermined cipher text.

When the cipher text to be verified is the same to the predetermined cipher text, in step S1309, the password to be verified is identified to be validated, and the second partition 504 is set as the storage partition.

When the cipher text to be verified is different to the predetermined cipher text, in step S1311, the password to be verified is identified to be invalidated, and a password error message is output.

### Third Exemplary Embodiment

The third exemplary embodiment is substantially the same to the first exemplary embodiment, and a difference there between is that the memory management circuit of the third exemplary embodiment uses a different method to perform ID verification. FIGS. 2A, 3A, 3B, 4A, 4B and 5 of the first exemplary embodiment are referenced to describe the difference of the first exemplary embodiment and the third exemplary embodiment.

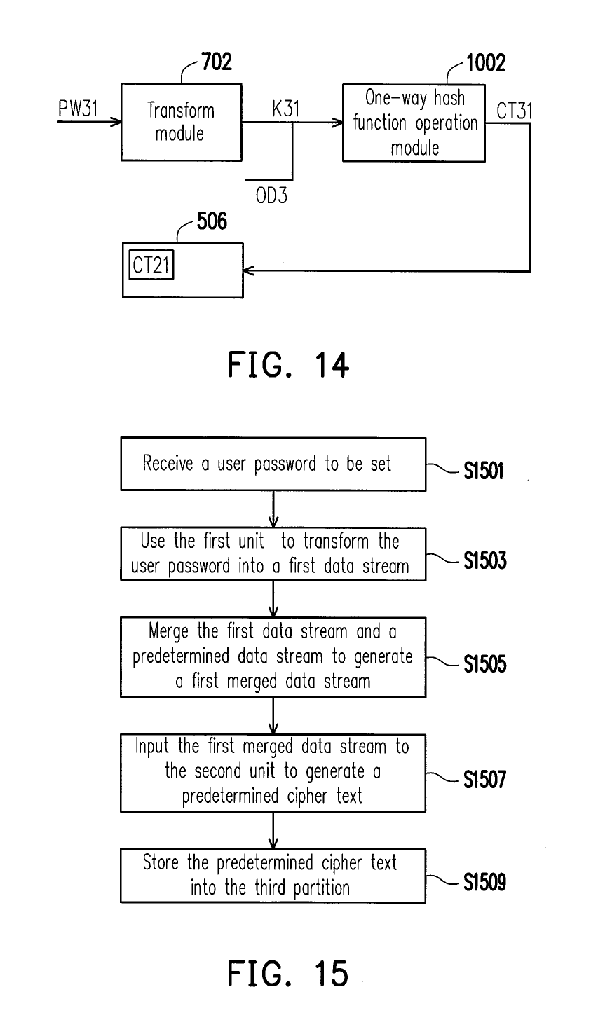

FIG. 14 is a schematic diagram of setting a user password according to the third exemplary embodiment of the present invention.

Referring to FIG. 14, after the user executes the password setting function in the password verification program executed on the host system 1000 to input a new user password PW31, the user password PW31 is transmitted to the memory storage apparatus 100. When the memory controller 104 receives the user password PW31, the memory management circuit 202 converts the user password PW31 into a data stream K31.

In detail, in the third exemplary embodiment, the transform module 702 and the one-way hash function operation module 1002 are configured in the memory storage apparatus 100 to respectively serve as the aforementioned first unit and second unit. The memory management circuit 202 uses the transform module 702 to transform an input data stream into an output data stream with a fixed length.

Then, the memory management circuit 202 merges the predetermined data stream OD1 and the data stream K31 to generate a merged data stream, and uses the one-way hash function operation module 1002 to generate a predetermined cipher text CT31 according to the merged data stream.

Then, the memory management circuit 202 stores the predetermined cipher text CT31 to the third partition 506 to complete the setting of the new user password.

FIG. 15 is a flowchart illustrating a method of setting the user password according to the third exemplary embodiment of the present invention.

Referring to FIG. 15, in step S1501, a user password to be set is received. Then, in step S1503, the first unit (for example, the transform module 702) is used to transform the user password into a data stream (which is referred to as a first data stream). In step S1505, the first data stream and a predetermined data stream are merged to generate a merged data stream (which is referred to as a first merged data stream). Then, in step S1507, the first merged data stream is input to the second unit (for example, the one-way hash function operation module 1002) to generate a predetermined cipher text. Finally, in step S1507, the predetermined cipher text is stored to the third partition 506.

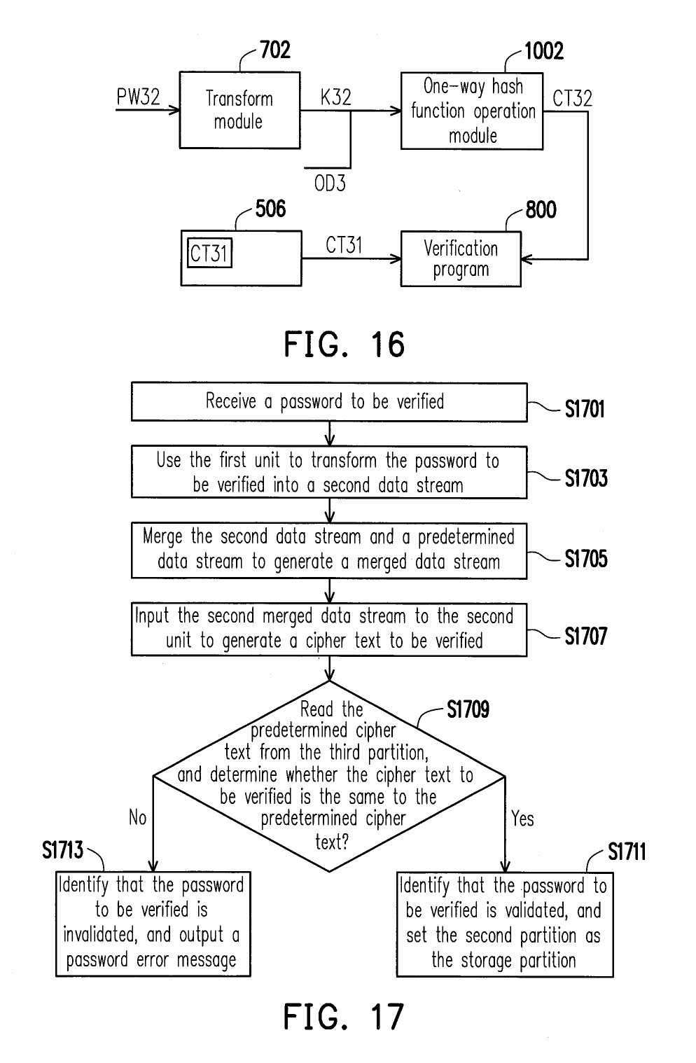

FIG. 16 is a schematic diagram of verifying the user ID according to the third exemplary embodiment of the present invention.

Referring to FIG. 16, when the user inputs a password PW32 (which is referred to as a password to be verified) according to the request of the password verification program, the password to be verified PW32 is transmitted to the memory storage apparatus 100.

When the memory controller 104 receives the password to be verified PW32, the memory management circuit 202 uses the transform module 702 to transform the password to be verified PW32 into a data stream K32.

Then, the memory management circuit 202 merges a predetermined data stream OD3 and the data stream K32 to generate the merged data stream, and outputs the merged data stream to the one-way hash function operation module 1002 to generate a cipher text to be verified CT32.

Then, the memory management circuit 202 reads the predetermined cipher text CT31 from the third partition 506 and performs a verification procedure 800 according to the cipher text to be verified CT32 and the predetermined cipher text CT31. In detail, if the password to be verified PW32 is the same to the user password PW31, the cipher text to be verified CT32 should be the same to the predetermined cipher text CT31. Comparatively, if the password to be verified PW32 is different to the user password PW31, the cipher text to be verified CT32 could be different to the predetermined cipher text CT31. Particularly, in case that the password to be verified is identified to be validated, the memory management circuit 202 sets the second partition 504 originally set as the hidden partition to the storage partition that can be accessed by the host system 1000.

FIG. 17 is a flowchart illustrating a method of verifying the user ID according to the third exemplary embodiment of the present invention.

Referring to FIG. 17, in step S1701, a password to be verified is received. Then, in step S1703, the first unit is used to transform the password to be verified into a data stream (which is referred to as a second data stream), and in step S1705, the second data stream and a predetermined data stream are merged to generate a merged data stream (which is referred to as a second merged data stream). Then, in step S1707, the second merged data stream is input to the second unit to generate a cipher text to be verified. Moreover, in step S1709, the predetermined cipher text is read from the third partition 506, and it is determined whether the cipher text to be verified is the same to the predetermined cipher text.

When the cipher text to be verified is the same to the predetermined cipher text, in step S1711, the password to be verified is identified to be validated, and the second partition 504 is set as the storage partition.

When the cipher text to be verified is different to the predetermined cipher text, in step S1713, the password to be verified is identified to be invalidated, and a password error message is output.

### Fourth Exemplary Embodiment

The fourth exemplary embodiment is substantially the same to the first exemplary embodiment, and a difference there between is that the memory management circuit of the fourth exemplary embodiment uses a different method to perform ID verification. FIGS. 2A, 3A, 3B, 4A, 4B and 5 of the first exemplary embodiment are referenced to describe the difference of the first exemplary embodiment and the fourth exemplary embodiment.

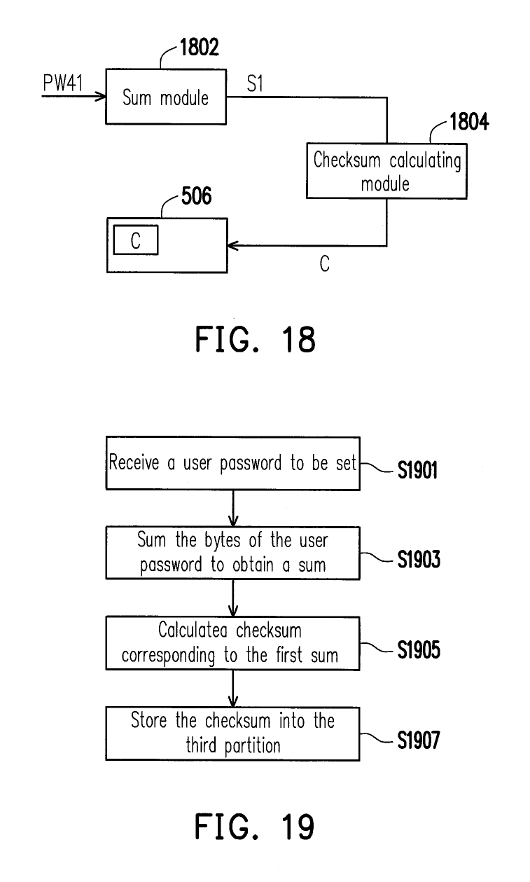

FIG. 18 is a schematic diagram of setting a user password according to the fourth exemplary embodiment of the present invention.

Referring to FIG. 18, after the user executes the password setting function in the password verification program executed on the host system 1000 to input a new user password PW41, the user password PW41 is transmitted to the memory storage apparatus 100. When the memory controller 104 receives the user password PW41, the memory management circuit 202 calculates a sum Si of the user password PW41.

In detail, in the fourth exemplary embodiment, a sum module 1802 and a checksum calculating module 1804 are configured in the memory storage apparatus 100. The memory management circuit 202 uses the sum module 1802 to sum a value of each byte of the user password PW41 to generate the sum S1. It should be noticed that in the present exemplary embodiment, although the sum module 1802 is implemented by a physical circuit, the present invention is not limited thereto, and in another exemplary embodiment of the present invention, the sum module 1802 may also be implemented by program codes.

Then, the memory management circuit 202 calculates a checksum C corresponding to the first sum S1. For example, the memory management circuit 202 uses the checksum calculating module 1804 to calculate the checksum C corresponding to the sum S1. In detail, the checksum C is a complement of the sum S1, where a sum of the sum S1 and the checksum C is equal to a predetermined sum. For example, the predetermined sum is a value with each bit to be 1. A calculating method of the checksum is known by those skilled in the art, and detailed descriptions thereof are not repeated. It should be noticed that in the present exemplary embodiment, although the checksum calculating module 1804 is implemented by a physical circuit, the present invention is not limited thereto, and in another exemplary embodiment of the present invention, the checksum calculating module 1804 may also be implemented by program codes.

Finally, the memory management circuit 202 stores the checksum C to the third partition to complete setting the new user password.

FIG. 19 is a flowchart illustrating a method of setting the user password according to the fourth exemplary embodiment of the present invention.

Referring to FIG. 19, in step S1901, a user password to be set is received. Then, in step S1903, the bytes of the user password are summed to obtain a sum (which is referred to as a first sum), and in step S1905, a checksum corresponding to the first sum is calculated. Finally, in step S1907, the checksum is stored to the third partition 506.

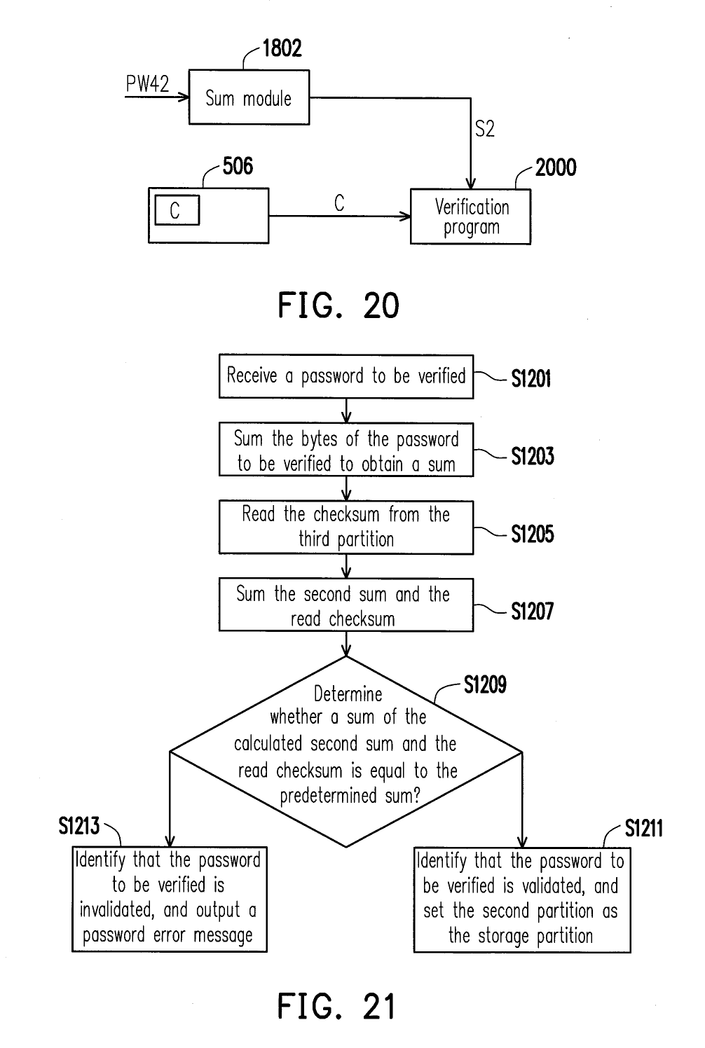

FIG. 20 is a schematic diagram of verifying the user ID according to the fourth exemplary embodiment of the present invention.

Referring to FIG. 20, when the user inputs a password PW42 (which is referred to as a password to be verified) according to the request of the password verification program, the password to be verified PW42 is transmitted to the memory storage apparatus 100.

When the memory controller 104 receives the password to be verified PW42, it calculates a sum S2 of the password to be verified PW42. Then, the memory management circuit 202 reads the checksum C from the third partition 506. Then, the memory management circuit 202 sums the calculated sum S2 and the check sum C to obtain a sum to be verified, and performs a verification procedure 2000 to determine whether the sum to be verified is equal to the predetermined sum. For example, the memory management circuit 202 determines whether a value of each of bits of the sum to be verified is 1. In detail, if the password to be verified PW42 is the same to the user password PW41, the sum to be verified should be the same to the predetermined sum, for example, the value of each of the bits of the sum to be verified is 1. Comparatively, if the password to be verified PW42 is different to the user password PW41, the sum to be verified could be different to the predetermined sum. Particularly, in case that the password to be verified is identified to be validated, the memory management circuit 202 sets the second partition 504 originally set as the hidden partition to the storage partition that can be accessed by the host system 1000.

FIG. 21 is a flowchart illustrating a method of verifying the user ID according to the fourth exemplary embodiment of the present invention.

Referring to FIG. 21, in step S2101, a password to be verified is received. Then, in step S2103, the bytes of the password to be verified are summed to obtain a sum (which is referred to as a second sum). Moreover, in step S2105, the checksum is read from the third partition 506. Then, in step 2107, the second sum and the read checksum are summed, and in step 1209, it is determined whether a sum of the calculated second sum and the read checksum is equal to the predetermined sum.

When the sum of the calculated second sum and the read checksum is equal to the predetermined sum, in step S2111, the password to be verified is identified to be validated, and the second partition 504 is set as the storage partition.

When the sum of the calculated second sum and the read checksum is different to the predetermined sum, in step S2113, the password to be verified is identified to be invalidated, and a password error message is output.

In summary, in the memory storage apparatus, the memory controller and the memory password verification method of the exemplary embodiments, the predetermined password and the password to be verified are compared to perform the ID verification, so as to effectively avoid unauthorized access of the memory storage apparatus. Moreover, in the memory storage apparatus, the memory controller and the memory password verification method of another exemplary embodiment, the sum of the password and the checksum are calculated to perform the ID verification, so as to effectively avoid unauthorized access of the memory storage apparatus. The previously described exemplary embodiments of the present invention have the advantages aforementioned, wherein the advantages aforementioned not required in all versions of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A memory storage apparatus, comprising:
a connector, coupled to a host system;
a rewritable non-volatile memory module; and
a memory controller, coupled to the connector and the rewritable non-volatile memory module,
wherein the memory controller receives a user password from the host system, uses a first unit to transform the user password into a first data stream and uses a second unit to generate a predetermined cipher text according to a predetermined data stream and the first data stream,
wherein the memory controller stores the predetermined cipher text into the rewritable non-volatile memory module,
wherein the memory controller receives a password to be verified from the host system, uses the first unit to transform the password to be verified into a second data stream, and uses the second unit to generate a cipher text to be verified according to the predetermined data stream and the second data stream,
wherein the memory controller reads the predetermined cipher text from the rewritable non-volatile memory module and determines whether the cipher text to be verified is the same to the predetermined cipher text,
wherein when the cipher text to be verified is the same to the predetermined cipher text, the memory controller identifies that the password to be verified is validated.

2. The memory storage apparatus as claimed in claim 1, wherein the rewritable non-volatile memory module has a plurality of physical blocks and a plurality of logical blocks mapping to a part of the physical blocks,
wherein the memory controller initially divides a part of the logical blocks into a hidden partition, wherein the host system is unable to recognize the hidden partition,
wherein after the password to be verified is identified to be validated, the memory controller switches the hidden partition to a storage partition accessible by the host system.

3. The memory storage apparatus as claimed in claim 1, wherein the rewritable non-volatile memory module has a plurality of physical blocks and a plurality of logical blocks mapping to a part of the physical blocks,
wherein the memory controller divides a part of the logical blocks into a storage partition and a confidential partition, wherein the host system is unable to recognize the confidential partition, and the confidential partition stores a partition key,
wherein the memory controller uses the partition key to encrypt data stored in the storage partition,
wherein when the password to be verified is identified to be validated, the memory controller uses the partition key to decrypt the data stored in the storage partition.

4. The memory storage apparatus as claimed in claim 1, wherein the second unit is an advanced encryption standard module,
wherein the memory controller uses the first unit to transform the user password into the first data stream with a fixed length and transform the password to be verified into the second data stream with the fixed length,
wherein the memory controller uses the second unit to encrypt the predetermined data stream with the first data stream to generate the predetermined cipher text,
wherein the memory controller uses the second unit to encrypt the predetermined data stream with the second data stream to generate the cipher text to be verified.

5. The memory storage apparatus as claimed in claim 1, wherein the first unit is a one-way hash function operation module, the second unit is an advanced encryption standard module, and the predetermined data stream has a fixed length,
wherein the memory controller uses the second unit to encrypt the first data stream with the predetermined data stream to generate the predetermined cipher text,
wherein the memory controller uses the second unit to encrypt the second data stream with the predetermined data stream to generate the cipher text to be verified.

6. The memory storage apparatus as claimed in claim 1, wherein the second unit is a one-way hash function operation module,
wherein the memory controller uses the first unit to transform the user password into the first data stream with a fixed length and transform the password to be verified into the second data stream with the fixed length,
wherein the memory controller merges the first data stream and the predetermined data stream to generate a first merged data stream, and uses the second unit to generate the predetermined cipher text according to the first merged data stream,
wherein the memory controller merges the second data stream and the predetermined data stream to generate a second merged data stream, and uses the second unit to generate the cipher text to be verified according to the second merged data stream.

7. A memory storage apparatus, comprising:
a connector, coupled to a host system;
a rewritable non-volatile memory module; and
a memory controller, coupled to the connector and the rewritable non-volatile memory module,
wherein the memory controller receives a user password having a plurality of bytes from the host system, sums the bytes of the user password to obtain a first sum, and calculates a checksum corresponding to the first sum,
wherein the first sum plus the checksum is equal to a predetermined sum,
wherein the memory controller stores the checksum into the rewritable non-volatile memory module,
wherein the memory controller receives a password to be verified and having a plurality of bytes from the host system, and sums the bytes of the password to be verified to obtain a second sum,
wherein the memory controller reads the checksum from the rewritable non-volatile memory module, and determines whether a sum of the second sum and the checksum is equal to the predetermined sum,
wherein when the sum of the second sum and the checksum is equal to the predetermined sum, the memory controller identifies that the password to be verified is validated.

8. The memory storage apparatus as claimed in claim 7, wherein the rewritable non-volatile memory module has a plurality of physical blocks and a plurality of logical blocks mapping to a part of the physical blocks,
wherein the memory controller initially divides a part of the logical blocks into a hidden partition, wherein the host system is unable to recognize the hidden partition,
wherein after the password to be verified is identified to be validated, the memory controller switches the hidden partition to a storage partition accessible by the host system.

9. The memory storage apparatus as claimed in claim 7, wherein the rewritable non-volatile memory module has a plurality of physical blocks and a plurality of logical blocks mapping to a part of the physical blocks,
wherein the memory controller divides a part of the logical blocks into a storage partition and a confidential partition, wherein the host system is unable to recognize the confidential partition, and the confidential partition stores a partition key,
wherein the memory controller uses the partition key to encrypt data stored in the storage partition,
wherein when the password to be verified is identified to be validated, the memory controller uses the partition key to decrypt the data stored in the storage partition.

10. A memory controller, comprising:
a host interface, coupled to a host system;
a memory interface, coupled to a rewritable non-volatile memory module; and
a memory management circuit, coupled to a connector and the rewritable non-volatile memory module,
wherein the memory management circuit receives a user password from the host system, uses a first unit to transform the user password into a first data stream, and uses a second unit to generate a predetermined cipher text according to a predetermined data stream and the first data stream,
wherein the memory management circuit stores the predetermined cipher text into the rewritable non-volatile memory module,
wherein the memory management circuit receives a password to be verified from the host system, uses the first unit to transform the password to be verified into a second data stream, and uses the second unit to generate a cipher text to be verified according to the predetermined data stream and the second data stream,
wherein the memory management circuit reads the predetermined cipher text from the rewritable non-volatile memory module and determines whether the cipher text to be verified is the same to the predetermined cipher text,
wherein when the cipher text to be verified is the same to the predetermined cipher text, the memory management circuit identifies that the password to be verified is validated.

11. The memory controller as claimed in claim 10, wherein the rewritable non-volatile memory module has a plurality of physical blocks and a plurality of logical blocks mapping to a part of the physical blocks,
wherein the memory management circuit initially divides a part of the logical blocks into a hidden partition, wherein the host system is unable to recognize the hidden partition,
wherein after the password to be verified is identified to be validated, the memory management circuit switches the hidden partition to a storage partition accessible by the host system.

12. The memory controller as claimed in claim 10, wherein the rewritable non-volatile memory module has a plurality of physical blocks and a plurality of logical blocks mapping to a part of the physical blocks,
wherein the memory management circuit divides a part of the logical blocks into a storage partition and a confidential partition, wherein the host system is unable to recognize the confidential partition, and the confidential partition stores a partition key,
wherein the memory management circuit uses the partition key to encrypt data stored in the storage partition,
wherein when the password to be verified is identified to be validated, the memory management circuit uses the partition key to decrypt the data stored in the storage partition.

13. The memory controller as claimed in claim 10, wherein the second unit is an advanced encryption standard module,
wherein the memory management circuit uses the first unit to transform the user password into the first data stream with a fixed length and transform the password to be verified into the second data stream with the fixed length,
wherein the memory management circuit uses the second unit to encrypt the predetermined data stream by the first data stream to generate the predetermined cipher text,
wherein the memory management circuit uses the second unit to encrypt the predetermined data stream by the second data stream to generate the cipher text to be verified.

14. The memory controller as claimed in claim 10, wherein the first unit is a one-way hash function operation module, the second unit is an advanced encryption standard module, and the predetermined data stream has a fixed length,
wherein the memory management circuit uses the second unit to encrypt the first data stream by the predetermined data stream to generate the predetermined cipher text,
wherein the memory management circuit uses the second unit to encrypt the second data stream by the predetermined data stream to generate the cipher text to be verified.

15. The memory controller as claimed in claim 10, wherein the second unit is a one-way hash function operation module,
wherein the memory management circuit uses the first unit to transform the user password into the first data stream with a fixed length and transform the password to be verified into the second data stream with the fixed length,
wherein the memory management circuit merges the first data stream and the predetermined data stream to generate a first merged data stream, and uses the second unit to generate the predetermined cipher text according to the first merged data stream,
wherein the memory management circuit merges the second data stream and the predetermined data stream to generate a second merged data stream, and uses the second unit to generate the cipher text to be verified according to the second merged data stream.

16. A memory controller, comprising:
a host interface, coupled to a host system;
a memory interface, coupled to a rewritable non-volatile memory module; and
a memory management circuit, coupled to a connector and the rewritable non-volatile memory module,
wherein the memory management circuit receives a user password having a plurality of bytes from the host system, sums the bytes of the user password to obtain a first sum, and calculates a checksum corresponding to the first sum,
wherein the first sum plus the checksum is equal to a predetermined sum,
wherein the memory management circuit stores the checksum to the rewritable non-volatile memory module,
wherein the memory management circuit receives a password to be verified and having a plurality of bytes from the host system, and sums the bytes of the password to be verified to obtain a second sum,
wherein the memory management circuit reads the checksum from the rewritable non-volatile memory module, and determines whether a sum of the second sum and the checksum is equal to the predetermined sum,
wherein when the sum of the second sum and the checksum is equal to the predetermined sum, the memory management circuit identifies that the password to be verified is validated.

17. The memory controller as claimed in claim 16, wherein the rewritable non-volatile memory module has a plurality of physical blocks and a plurality of logical blocks mapping to a part of the physical blocks,
wherein the memory management circuit initially divides a part of the logical blocks into a hidden partition, wherein the host system is unable to recognize the hidden partition,
wherein after the password to be verified is identified to be validated, the memory management circuit switches the hidden partition to a storage partition accessible by the host system.

18. The memory controller as claimed in claim 16, wherein the rewritable non-volatile memory module has a plurality of physical blocks and a plurality of logical blocks mapping to a part of the physical blocks,
wherein the memory management circuit divides a part of the logical blocks into a storage partition and a confidential partition, wherein the host system is unable to recognize the confidential partition, and the confidential partition stores a partition key,
wherein the memory management circuit uses the partition key to encrypt data stored in the storage partition,
wherein when the password to be verified is identified to be validated, the memory management circuit uses the partition key to decrypt the data stored in the storage partition.

19. A password verification method, for a memory storage apparatus having a rewritable non-volatile memory module, the password verification method comprising:
receiving a user password, using a first unit to transform the user password into a first data stream, and inputting a predetermined data stream and the first data stream to a second unit to generate a predetermined cipher text;
storing the predetermined cipher text into the rewritable non-volatile memory module;
receiving a password to be verified, using the first unit to transform the password to be verified into a second data stream, and inputting the predetermined data stream and the second data stream to the second unit to generate a cipher text to be verified;
reading the predetermined cipher text from the rewritable non-volatile memory module, and determining whether the cipher text to be verified is the same to the predetermined cipher text; and
identifying that the password to be verified is validated when the cipher text to be verified is the same to the predetermined cipher text.

20. The password verification method as claimed in claim 19, wherein the second unit is an advanced encryption standard module,
wherein the step of using the first unit to transform the user password into the first data stream comprises using the first unit to transform the user password into the first data stream with a fixed length,
wherein the step of using the first unit to transform the password to be verified into the second data stream comprises using the first unit to transform the password to be verified into the second data stream with the fixed length,
wherein the step of inputting the predetermined data stream and the first data stream to the second unit to generate the predetermined cipher text comprises using the second unit to encrypt the predetermined data stream with the first data stream to generate the predetermined cipher text,
wherein the step of inputting the predetermined data stream and the second data stream to the second unit to generate the cipher text to be verified comprises using the second unit to encrypt the predetermined data stream with the second data stream to generate the cipher text to be verified.

21. The password verification method as claimed in claim 19, wherein the first unit is a one-way hash function operation module, the second unit is an advanced encryption standard module, and the predetermined data stream has a fixed length,
wherein the step of inputting the predetermined data stream and the first data stream to the second unit to generate the predetermined cipher text comprises using the second unit to encrypt the first data stream with the predetermined data stream to generate the predetermined cipher text,
wherein the step of inputting the predetermined data stream and the second data stream to the second unit to generate the cipher text to be verified comprises using the second unit to encrypt the second data stream with the predetermined data stream to generate the cipher text to be verified.

22. The password verification method as claimed in claim 19, wherein the second unit is a one-way hash function operation module,
wherein the step of using the first unit to transform the user password into the first data stream comprises using the first unit to transform the user password into the first data stream with a fixed length,
wherein the step of using the first unit to transform the password to be verified into the second data stream comprises using the first unit to transform the password to be verified into the second data stream with the fixed length,
wherein the step of inputting the predetermined data stream and the first data stream to the second unit to generate the predetermined cipher text comprises merging the first data stream and the predetermined data stream to generate a first merged data stream, and inputting the first merged dada stream to the second unit to generate the predetermined cipher text,
wherein the step of inputting the predetermined data stream and the second data stream to the second unit to generate the cipher text to be verified comprises merging the second data stream and the predetermined data stream to generate a second merged data stream, and inputting the second merged data stream to the second unit to generate the cipher text to be verified.

23. A password verification method, for a memory storage apparatus having a rewritable non-volatile memory module, the password verification method comprising:
receiving a user password having a plurality of bytes;
summing the bytes of the user password to obtain a first sum;
calculating a checksum corresponding to the first sum, wherein the first sum plus the checksum is equal to a predetermined sum;
storing the checksum into the rewritable non-volatile memory module;
receiving a password to be verified, wherein the password to be verified has a plurality of bytes;
summing the bytes of the password to be verified to obtain a second sum;
reading the checksum from the rewritable non-volatile memory module, and determining whether a sum of the second sum and the checksum is equal to the predetermined sum; and
identifying that the password to be verified is validated when the sum of the second sum and the checksum is equal to the predetermined sum.

24. A password verification method, for a memory storage apparatus having a rewritable non-volatile memory module, the password verification method comprising:
receiving a user password, and using a first unit to transform the user password into a first data stream;
using a second unit to transform the first data stream into authentication data different to the first data stream;
storing the authentication data into the rewritable non-volatile memory module;
receiving a password to be verified, using the first unit to transform the password to be verified into a second data stream, and generating data to be verified through the second unit;
reading the authentication data from the rewritable non-volatile memory module, and determining whether the data to be verified and the authentication data are complied with a predetermined rule; and
identifying that the password to be verified is validated when the data to be verified and the authentication data are complied with the predetermined rule.
